(19) United States
(12) Patent Application Publication
(10) Pub. No.: US 2026/0314870 A1
(43) Pub. Date: Oct. 15, 2026

(54) ELECTRICALLY CONTROLLED COFFEE BREWING AND FILTERING APPARATUS

(71) Applicant: PEIFAN LUO, Dongguan (CN)

(72) Inventor: PEIFAN LUO, Dongguan (CN)

(21) Appl. No.: 19/456,472

(22) Filed: Jan. 22, 2026

(30) Foreign Application Priority Data
Apr. 9, 2025 (CN) 202520664937.2

(51) Int. Cl. A47J 31/52; A47J 31/06

(52) U.S. Cl. CPC A47J 31/52; A47J 31/0657

(57) ABSTRACT

An electrically controlled coffee brewing and filtering apparatus comprises a filter cup with a steeping chamber, a microporous filter screen positioned above a water-outlet opening, and a lower mounting cavity. The cavity houses an air pump, a PCB control board, and a battery. An air-inlet port formed in the bottom of the filter cup and a vent port open to atmosphere connect to the pump's inlet and outlet, together defining an independent exhaust passage whose opening and closing are electronically controlled. When the pump is activated, air is drawn through the inlet and expelled through the vent, reducing pressure in an attached drinking cup. This pressure differential accelerates the flow of steeped infusion through the filter screen and outlet, rapidly producing a cleaner, higher-quality beverage with less manual effort.

### FIELD OF THE INVENTION

The present invention relates to the field of coffee-brewing technology and, more particularly, to an electrically controlled apparatus for brewing and filtering coffee.

### BACKGROUND OF THE INVENTION

Brewing ground coffee beans with hot water on demand is a common method for preparing coffee beverages. During preparation, factors such as the grind size of the coffee grounds, steeping time, water temperature, and filtration rate decisively affect the flavor and quality of the final product. Because spent grounds must be removed before consumption, an efficient filtration step is essential to achieve a smooth mouthfeel.

Chinese Patent Application No. 202323070176.8 discloses a coffee filter cup that includes a lower cup body having an open-topped hollow structure, an upper cup body threaded to the top of the lower cup body and itself formed as a hollow structure with openings at both ends, and a screw-on cup lid. The upper cup body is provided with a drip-filter plate and has a conical shape. In use, the lower cup body can serve as a standalone drinking cup, or the upper and lower bodies can be combined as a single cup. To brew drip coffee, the upper cup body is inverted onto the lower cup body, a coffee filter paper is placed on the filter plate, and ground coffee is loaded for brewing, with the brewed coffee dripping into the lower cup body.

Although this design employs a drip-filter plate with a paper filter, its filtration efficiency is low, affords no means of accelerating filtration, and requires manual replacement of the paper filter. The operation is therefore tedious and inconvenient, causing considerable user frustration.

In view of the foregoing shortcomings, the present inventor has developed the following technical solution.

### SUMMARY OF THE INVENTION

An object of the present invention is to overcome deficiencies of the prior art and to provide an electrically controlled coffee brewing and filtering apparatus.

To achieve the foregoing object, the apparatus comprises: a filter cup defining a steeping chamber and a microporous filter screen disposed at a bottom of the steeping chamber; a water-outlet opening extending through a lower end of the filter cup and communicating with an interior of the filter cup, the microporous filter screen being positioned above the water-outlet opening; and a mounting cavity provided in a lower portion of the filter cup. The mounting cavity houses an air pump, a PCB control board configured to control operation of the air pump, and a battery. A bottom wall of the filter cup is formed with an air-inlet port, and the filter cup further includes a vent port communicating with ambient surroundings. An inlet port and an outlet port of the air pump are pneumatically connected to the air-inlet port and the vent port, respectively, thereby defining a independent exhaust passage whose opening and closing are electrically controllable.

According to a further aspect of the invention, the lower portion of the filter cup additionally includes a coupling portion adapted to mate with a drinking cup. The air-inlet port and the water-outlet opening extend through a bottom of the coupling portion and communicate with an interior of the drinking cup. A downwardly projecting boss is provided outside the coupling portion. The vent port extends through a lower end surface of the boss, and the boss defines, along an outer surface thereof, a notch communicating with the vent port. After assembly of the filter cup to the drinking cup, the notch communicates a gap between the filter cup and the drinking cup with ambient surroundings.

According to another aspect, the inlet and outlet ports of the air pump are connected to an air-inlet tube and an air-outlet tube, respectively; the air-inlet tube communicates with the air-inlet port and the air-outlet tube communicates with the vent port. A check valve is disposed on the air-inlet tube or the air-outlet tube and remains in a closed state while the air pump is inactive; when the air pump is activated, airflow opens the check valve.

According to still another aspect, an external surface of the filter cup carries a control switch and a charging interface that are electrically connected to the PCB control board.

According to yet another aspect, a stepped groove is formed in a bottom of the interior of the filter cup. An outer edge of the microporous filter screen is seated in the stepped groove, and a retaining ring is press-fitted into the groove to press against an outer surface of the filter screen and secure it in place.

Preferably, an inner wall of the retaining ring is formed with an inclined protruding tab that facilitates removal of the retaining ring, and an outer surface of the retaining ring includes a positioning portion that is further engaged within a positioning groove provided in an inner wall of the stepped groove.

Preferably, a bottom surface of the steeping chamber is inclined, a lowest point of the inclined surface communicating with the water-outlet opening, and a support portion projects from a central region of the bottom surface of the steeping chamber to bear against a bottom surface of the microporous filter screen.

Preferably, the filter cup is assembled, in a top-to-bottom sealed stack, from a cup body, an intermediate seat, and a cup base. The mounting cavity is defined between the intermediate seat and the cup base, while the steeping chamber is defined between the cup body and the intermediate seat. The air-inlet port and the vent port are both provided in the cup base.

Preferably, the cup body has a double-layer structure comprising an outer cup shell and an inner liner integrally fixed within the outer cup shell, a spacing being formed between the outer wall of the liner and an inner wall of the shell, and the liner being shaped larger at an upper end and smaller at a lower end.

Preferably, a first downwardly projecting water tube is provided at a lower end of the cup body, a second downwardly projecting water tube at a lower end of the intermediate seat, and a third downwardly projecting water tube at a lower end of the cup base. A first sealing ring is sleeved on an outer surface of a lower end of the first water tube and is inserted from above into an upper end of the second water tube to form a sealed joint. A second sealing ring is sleeved on an outer surface of a lower end of the second water tube and is inserted from above into an upper end of the third water tube to form a sealed joint. Inner bores of the first, second, and third water tubes are aligned to cooperatively define the water-outlet opening.

Compared with the prior art, the invention offers the following advantages:
Accelerated filtration: The filter cup has a standalone exhaust passage whose opening and closing are controlled by an air pump. By exploiting atmospheric-pressure differentials, the apparatus accelerates filtration of the steeped coffee infusion, enabling rapid preparation of higher-quality coffee.
Electrification and automation: Electrically actuated control reduces manual steps, making operation simpler, less labor-intensive, and more reliable.
Compact, integratable design: The miniaturized, all-in-one filter cup can be detachably combined with various drinking cups, facilitating portability and convenient use.

Accordingly, the invention provides a safe, efficient, and user-friendly solution for brewing and filtering coffee.

### BRIEF DESCRIPTION OF THE DRAWINGS

FIG. 1 is a perspective view of the electrically-controlled coffee-brewing and filtering apparatus of the invention;

FIG. 2 is another perspective view of the apparatus taken from a different angle;

FIG. 3 is an exploded perspective view of the apparatus;

FIG. 4 is an internal structural view of the apparatus;

FIG. 5 is a perspective view of a filter-cup base of the apparatus;

FIG. 6 is a sectional view of the apparatus;

FIG. 7 is a perspective view of the filter-cup base taken from another angle;

FIG. 8 is a schematic view showing the apparatus assembled with a drinking cup in a state of use;

FIG. 9 is an operational illustration showing the apparatus assembled with a drinking cup.

### DETAILED DESCRIPTION OF PREFERRED EMBODIMENTS

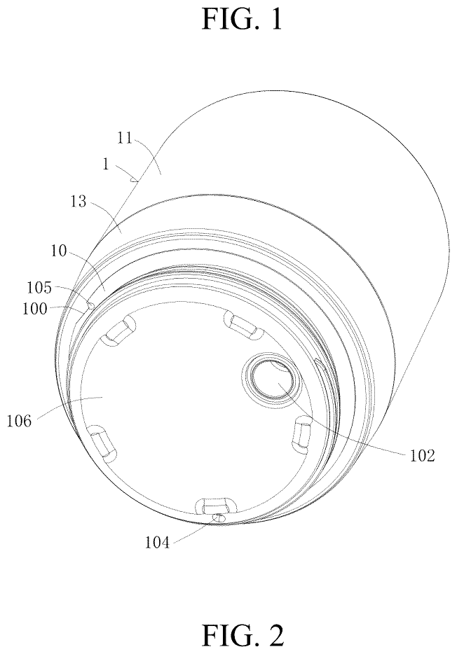

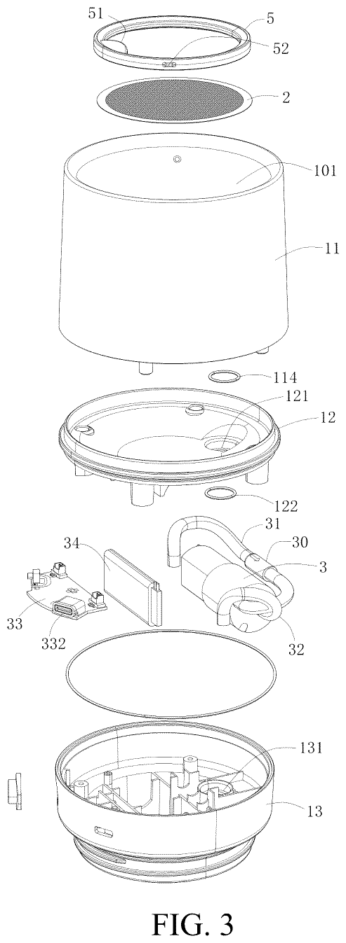

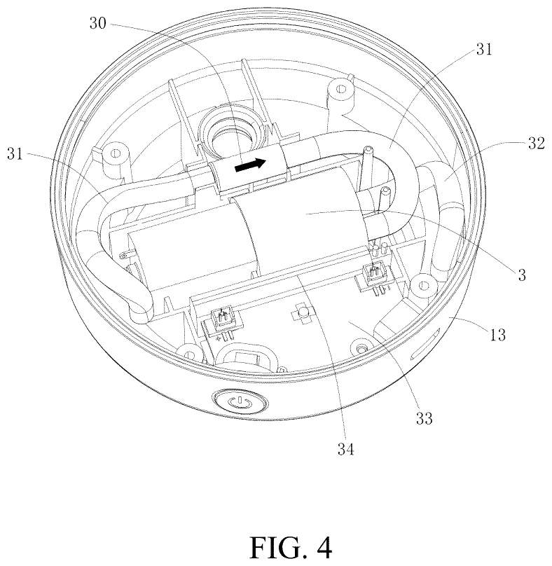

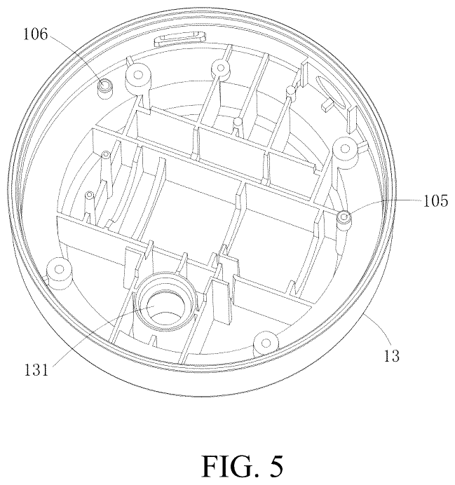

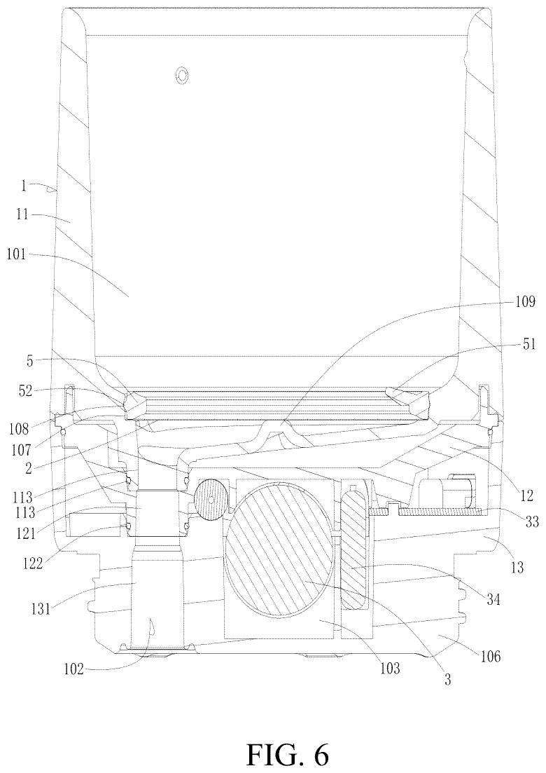

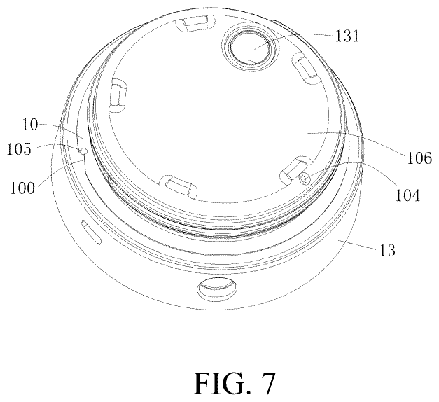

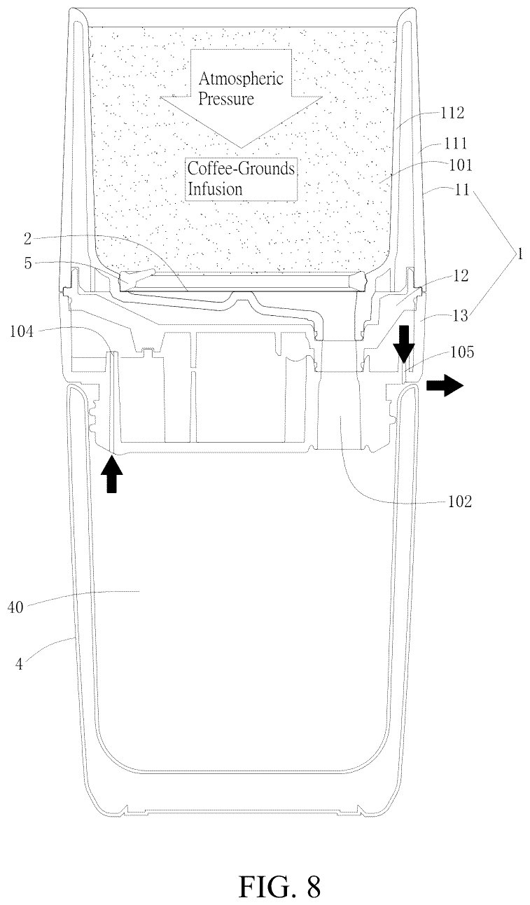

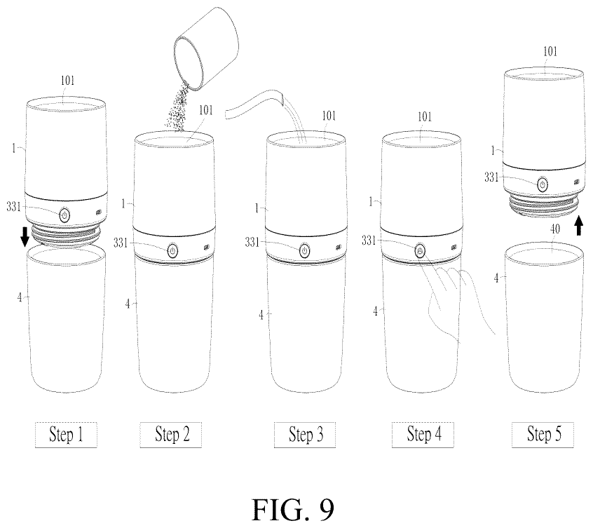

Reference is now made to FIGS. 1-9, which illustrate an electrically-controlled coffee-brewing and filtering apparatus comprising a filter cup 1 and a microporous filter screen 2.

In the present embodiment, the filter cup 1 defines a steeping chamber 101 for receiving coffee grounds (or powder) together with hot water so that the coffee can steep. The microporous filter screen 2 is arranged at a bottom of the steeping chamber 101 and serves to filter out coffee residues, thereby producing a beverage after brewing. A water-outlet opening 102 extends through a lower end of the filter cup 1 and communicates with an interior of the filter cup; the microporous filter screen 2 is positioned above the water-outlet opening 102 so that the steeped coffee infusion, after passing through the screen 2, exits through the water-outlet opening 102.

The invention introduces the following principal improvement. A mounting cavity 103 is provided in a lower portion of the filter cup 1, the mounting cavity housing an air pump 3, a PCB control board 33 for controlling operation of the air pump 3, and a battery 34. A bottom wall of the filter cup is formed with an air-inlet port 104, and the filter cup further includes a vent port 105 that communicates with ambient surroundings. An inlet port and an outlet port of the air pump 3 are pneumatically connected to the air-inlet port 104 and the vent port 105, respectively, thereby defining a standalone exhaust passage whose opening and closing are electrically controllable.

During use, the filter cup 1 is mated to a drinking cup 4 such that the drinking cup 4 is fixed to a lower end of the filter cup 1, creating a sealed containing space 40 inside the drinking cup 4. In an initial state in which the air pump 3 is not running, coffee grounds (or powder) and hot water are poured in sequence into the steeping chamber 101 to form a coffee-grounds infusion. Because surface tension of the infusion at the microporous filter screen 2 is sufficiently high, a gas seal is formed by the air between the filter cup 1 and the drinking cup 4, and the pressure in the containing space balances with ambient atmospheric pressure. The infusion is thus supported on the filter screen 2 while the coffee grounds steep in the hot water—i.e., the brewing state.

After the grounds have been sufficiently extracted, the air pump 3 is started, thereby opening the exhaust passage. Air present between the filter cup and the drinking cup is continuously expelled through the exhaust passage-entering via the air-inlet port 104, passing through the air pump 3, and being discharged via the vent port 105. As a result, pressure in the containing space 40 of the drinking cup 4 decreases, atmospheric pressure forces the infusion to accelerate through the filter screen 2, and the infusion flows through the water-outlet opening 102 into the containing space 40, rapidly completing filtration. A coffee beverage of improved quality is thus obtained; the filter cup 1 is then removed, leaving a ready-to-drink cup of coffee.

Accordingly, the invention provides a filter cup having an independent exhaust passage whose opening and closing are governed by the air pump. By exploiting atmospheric-pressure differentials, the apparatus accelerates filtration of the steeped coffee infusion, achieving electrified and automated control, reducing manual steps, simplifying operation, enhancing safety and reliability, and improving filtration efficiency to yield a superior beverage. Moreover, the filter cup is miniaturized and integrated, may be detachably combined with various drinking cups, and is convenient to carry and use.

In order to further improve the airtightness of the exhaust passage, a check valve 30 is additionally provided; that is, either the inlet port or the outlet port of the air pump 3 is connected to the check valve 30, so that the entire exhaust passage is conductive in only one direction-namely, exhaustion to the outside-while external air cannot enter, thereby ensuring that, when the drinking cup 4 is later secured to the lower end of the filter cup 1, the sealed containing space 40 inside the drinking cup 4 is rendered even more airtight.

Among them, the inlet and outlet ports of the air pump 3 are respectively connected to an air-inlet tube 31 and an air-outlet tube 32, the air-inlet tube 31 being connected to the air-inlet port 104 and the air-outlet tube 32 being connected to the vent port 105. The air-inlet tube 31 or the air-outlet tube 32 is further provided with the aforementioned check valve 30; when the air pump 3 is not running, the check valve 30 is in a closed state, and when the air pump 3 is started, the airflow opens the check valve 30. Both the air-inlet tube 31 and the air-outlet tube 32 are made of flexible rubber hose, making it easy to bend them as required during assembly and thus simplifying installation. The check valve 30 is a conventional check valve and will not be described in detail here; it remains non-conductive in its normal state and is driven open by the airflow generated by the air pump, and those skilled in the art can readily select a suitable check valve.

The assembly structure of the filter cup 1 and the microporous filter screen 2 in the present invention is as follows: a stepped groove 107 is formed in a bottom of the interior of the filter cup 1, the outer edge of the microporous filter screen 2 is mounted in the stepped groove 107, and a retaining ring 5 is press-fitted into the stepped groove 107 to press against the outer surface of the microporous filter screen 2, thereby fixing the microporous filter screen 2 within the stepped groove 107; the assembly is structurally simple and easy to install. The outer surface of the retaining ring 5 is formed with a positioning portion 52, which is further embedded in a positioning groove 108 provided in an inner wall of the stepped groove 107, ensuring that the retaining ring 5 is more stably mounted in the stepped groove 107 and preventing accidental disengagement of the retaining ring 5.

To facilitate removal of the retaining ring 5, the structure of the retaining ring 5 has been improved as follows: the inner wall of the retaining ring 5 is formed with an inclined protruding tab 51 that facilitates disassembly; the protruding tab 51 allows a user to pinch it with fingers (or engage it with a tool) to pull the entire retaining ring 5 and the filter screen 2 downward out of the filter cup 1, making disassembly very convenient.

The bottom surface of the steeping chamber 101 is inclined, and the lowest point of the inclined surface communicates with the water-outlet opening 102, which facilitates liquid flow inside the steeping chamber 101 and ensures that all liquid flows toward the water-outlet opening 102, avoiding residual liquid. In addition, a support portion 109 is provided at a central region of the bottom surface of the steeping chamber 101; an upper end of the support portion 109 contacts the underside of the microporous filter screen 2, thereby supporting the screen, stabilizing its installation, preventing the center of the screen from sagging, and ensuring its integrity.

In order to connect and mount the filter cup 1 to the drinking cup 4, the lower portion of the filter cup 1 is further provided with a coupling portion 106 for assembly with the drinking cup 4; that is, the filter cup 1 of the present invention is assembled to the upper end of the drinking cup 4 by means of the coupling portion 106. The coupling portion 106 and the upper end of the drinking cup 4 may be joined by threaded engagement or by a twist-and-lock bayonet. In this embodiment, the coupling portion 106 is threaded to the upper end of the drinking cup 4, providing a stable mounting structure and enhancing sealing performance, and a waterproof sealing ring is provided between the filter cup 1 and the drinking cup 4.

The air-inlet port 104 and the water-outlet opening 102 both penetrate a bottom of the coupling portion 106, so that, after assembly of the filter cup 1 to the upper end of the drinking cup 4 via the coupling portion 106, the air-inlet port 104 and the water-outlet opening 102 communicate with the interior of the drinking cup 4. To enhance the appearance of the filter cup 1 and to prevent the vent port 105 from being clogged by foreign matter, the following design is adopted: the lower portion of the filter cup 1 is further provided with a downwardly projecting boss 10 located outside the coupling portion 106, the vent port 105 penetrates a lower end face of the boss 10, and the boss 10 is formed, along its outer surface, with a notch 100 that communicates with the vent port 105. After assembly of the filter cup 1 to the drinking cup 4, the lower end face of the boss 10 abuts an upper end face of the drinking cup 4, thereby creating a gap between the outer side of the boss 10 and the upper end face of the drinking cup 4; at this time, the notch 100 communicates the gap between the filter cup 1 and the drinking cup 4 with the exterior, so that the vent port 105 is in communication with the outside atmosphere. This hidden-vent design not only improves the appearance of the filter cup 1 but also prevents the vent port 105 from becoming clogged by foreign matter.

The outer surface of the filter cup 1 is provided with a control switch 331 and a charging interface 332, both electrically connected to the PCB control board 33. The control switch 331 controls operation of the air pump, and an external charging cable can be connected to the charging interface 332 to recharge the battery.

The specific structure of the filter cup 1 is as follows, and it mainly comprises three components, namely: the filter cup 1 includes, from top to bottom and sealed in sequence, a filter-cup body 11, a filter-cup intermediate seat 12, and a filter-cup base 13; an installation cavity 103 is formed between the filter-cup intermediate seat 12 and the filter-cup base 13, and a steeping chamber 101 is formed between the filter-cup body 11 and the filter-cup intermediate seat 12; the air-inlet port 104 and the vent port 105 are both provided in the filter-cup base 13.

In some embodiments, the filter-cup body 11 is a single-layer structure. In other embodiments, the filter-cup body 11 is a double-layer structure that achieves heat-insulating and scald-preventing functions. The filter-cup body 11 includes an outer cup shell 111 and an inner liner 112 integrally fixed inside the outer cup shell 111; a gap is formed between an outer wall of the inner liner 112 and an inner wall of the outer cup shell 111, and the inner liner 112 is shaped larger at the top and smaller at the bottom, which is unfavorable to liquid flow.

The lower end of the filter-cup body 11 is provided with a downwardly projecting first water tube 113, the lower end of the filter-cup intermediate seat 12 is provided with a downwardly projecting second water tube 121, and the lower end of the filter-cup base 13 is provided with a downwardly projecting third water tube 131; an outer surface of the lower end of the first water tube 113 is sleeved with a first sealing ring 114 and is inserted from above into an upper end of the second water tube 121 to form a sealed assembly; an outer surface of the lower end of the second water tube 121 is sleeved with a second sealing ring 122 and is inserted from above into an upper end of the third water tube 131 to form a sealed assembly, and inner bores of the first water tube 113, the second water tube 121, and the third water tube 131 are aligned to cooperatively form the aforesaid water-outlet opening 102, resulting in a simple assembly structure and a leak-free water-outlet opening 102.

In summary, the filter cup 1 of the present invention is provided with an independent exhaust passage, and an air pump is employed to control opening and closing of the exhaust passage; by utilizing atmospheric-pressure principles, the apparatus accelerates filtration of the steeped coffee infusion, thereby realizing electrified or automated control, reducing manual steps, simplifying operation, enhancing safety and reliability, and improving filtration efficiency to obtain a higher-quality coffee beverage. In addition, the invention adopts a miniaturized and integrated filter cup that can be combined with various drinking cups serving as cup bodies and forms a detachable structure, making it convenient to carry and use.

Of course, the foregoing description is merely specific embodiments of the present invention and is not intended to limit the scope of implementation of the invention; any equivalent modifications or variations made in accordance with the structures, features, and principles set forth in the scope of the present patent application shall be included within the scope of the present patent application.

1. An electrically controlled coffee brewing and filtering apparatus, comprising:
a filter cup (1) defining a steeping chamber (101);
a microporous filter screen (2) disposed at a bottom of the steeping chamber (101); and
a water-outlet opening (102) extending through a lower end of the filter cup (1) and communicating with an interior of the filter cup, the microporous filter screen (2) being positioned above the water-outlet opening (102);
wherein a mounting cavity (103) is provided in a lower portion of the filter cup (1), the mounting cavity housing:
an air pump (3);
a PCB control board (33) configured to control operation of the air pump (3); and
a battery (34);
the filter cup (1) further including:
an air-inlet port (104) formed in a bottom wall of the filter cup; and
a vent port (105) that communicates with an exterior of the apparatus;
an inlet port and an outlet port of the air pump (3) being pneumatically connected to the air-inlet port (104) and the vent port (105), respectively, thereby defining an independent exhaust passage, the opening and closing of which are electrically controllable.

2. The electrically controlled coffee brewing and filtering apparatus according to claim 1, wherein:
the lower portion of the filter cup (1) further comprises a coupling portion (106) configured to be assembled to a drinking cup (4);
the air-inlet port (104) and the water-outlet opening (102) both extend through a bottom of the coupling portion (106) and communicate with an interior of the drinking cup (4);
the lower portion of the filter cup (1) further includes a downwardly projecting boss (10) located outside the coupling portion (106);
the vent port (105) extends through a lower end surface of the boss

(10) and the boss (10) defines, along an outer surface thereof, a notch (100) communicating with the vent port (105); and
after assembly of the filter cup (1) to the drinking cup (4), the notch (100) communicates a gap between the filter cup (1) and the drinking cup (4) with ambient surroundings.

3. The electrically controlled coffee brewing and filtering apparatus according to claim 1, wherein:
an air-inlet tube (31) and an air-outlet tube (32) are connected to the inlet port and the outlet port of the air pump (3), respectively;
the air-inlet tube (31) is in pneumatic communication with the air-inlet port (104), and the air-outlet tube (32) is in pneumatic communication with the vent port (105); and
a check valve (30) is disposed on the air-inlet tube (31) or the air-outlet tube (32), the check valve (30) being in a closed state while the air pump (3) is inactive and being forced open by airflow generated when the air pump (3) is activated.

4. The electrically controlled coffee brewing and filtering apparatus according to claim 1, wherein an external surface of the filter cup (1) is provided with a control switch (331) and a charging interface (332) that are electrically connected to the PCB control board (33).

5. The electrically controlled coffee brewing and filtering apparatus according to claim 1, wherein:
a stepped groove (107) is formed in a bottom of the interior of the filter cup (1);
an outer edge of the microporous filter screen (2) is seated in the stepped groove (107); and
a retaining ring (5) is press-fitted into the stepped groove (107) and presses against an outer surface of the microporous filter screen (2) so as to secure the microporous filter screen (2) within the stepped groove (107).

6. The electrically controlled coffee brewing and filtering apparatus according to claim 5, wherein:
an inner wall of the retaining ring (5) is formed with an inclined protruding tab (51) that facilitates removal of the retaining ring (5); and
an outer surface of the retaining ring (5) is formed with a positioning portion (52) that is further engaged within a positioning groove (108) provided in an inner wall of the stepped groove (107).

7. The electrically controlled coffee brewing and filtering apparatus according to claim 5, wherein:
a bottom surface of the steeping chamber (101) is inclined, a lowest point of the inclined surface communicating with the water-outlet opening (102); and
a support portion (109) is provided at a central region of the bottom surface of the steeping chamber (101), an upper end of the support portion

(109) contacting a bottom surface of the microporous filter screen (2) to provide support thereto.

8. The electrically controlled coffee brewing and filtering apparatus according to claim 1, wherein:
the filter cup (1) comprises, in a top-to-bottom sealed assembly, a cup body (11), an intermediate seat (12), and a cup base (13);
the mounting cavity (103) is defined between the intermediate seat (12) and the cup base (13);
the steeping chamber (101) is defined between the cup body (11) and the intermediate seat (12); and
the air-inlet port (104) and the vent port (105) are both provided in the cup base (13).

9. The electrically controlled coffee brewing and filtering apparatus according to claim 8, wherein the cup body (11) has a double-layer structure comprising an outer cup shell (111) and an inner liner (112) integrally fixed within the outer cup shell (111), a spacing being formed between an outer wall of the inner liner (112) and an inner wall of the outer cup shell (111), and the inner liner (112) having a shape that is larger at an upper portion and smaller at a lower portion.

10. The electrically controlled coffee brewing and filtering apparatus according to claim 8, wherein:
a first downwardly-projecting water tube (113) is provided at a lower end of the cup body (11);
a second downwardly-projecting water tube (121) is provided at a lower end of the intermediate seat (12);
a third downwardly-projecting water tube (131) is provided at a lower end of the cup base (13);
a first sealing ring (114) is sleeved on an outer surface of a lower end of the first water tube (113) and is inserted from above into an upper end of the second water tube (121) to form a sealed assembly;
a second sealing ring (122) is sleeved on an outer surface of a lower end of the second water tube (121) and is inserted from above into an upper end of the third water tube (131) to form a sealed assembly; and
inner bores of the first, second, and third water tubes (113, 121, 131) are aligned to cooperatively define the water-outlet opening (102).
